(19) United States
(12) Patent Application Publication
(10) Pub. No.: US 2024/0212894 A1
(43) Pub. Date: Jun. 27, 2024

(54) FERRITE SINTERED BODY AND MULTILAYER COIL COMPONENT

(71) Applicant: Murata Manufacturing Co., Ltd., Kyoto-fu (JP)

(72) Inventor: Kazutoshi SUGII, Nagaokakyo-shi (JP)

(73) Assignee: Murata Manufacturing Co., Ltd., Kyoto-fu (JP)

(21) Appl. No.: 18/426,915

(22) Filed: Jan. 30, 2024

Related U.S. Application Data
(63) Continuation of application No. PCT/JP2022/035598, filed on Sep. 26, 2022.

(30) Foreign Application Priority Data
Oct. 7, 2021 (JP) 2021-165461

(51) Int. Cl. H01F 1/03; C04B 35/26; H01F 5/06

(52) U.S. Cl. CPC H01F 1/0315; C04B 35/265; H01F 5/06; C04B 2235/3274; C04B 2235/785; C04B 2235/80

(57) ABSTRACT

A ferrite sintered body contains a main component and a sub component. The main component contains from 4 mol % to 13 mol % of Fe in terms of Fe₂O₃, from 47 mol % to 58 mol % of Zn in terms of ZnO, from 1 mol % to 4 mol % of Cu in terms of CuO, from 2 mol % to 8 mol % of Ni in terms of NiO, and from 28 mol % to 36 mol % of Si in terms of SiO₂. The sub component contains, per 100 parts by weight of the main component, from 0.8 parts by weight to 3 parts by weight of Bi in terms of Bi₂O₃ and from 0.005 parts by weight to 0.1 parts by weight of Zr in terms of ZrO₂.

### CROSS-REFERENCE TO RELATED APPLICATIONS

This application claims benefit of priority to International Patent Application No. PCT/JP2022/035598, filed Sep. 26, 2022, and to Japanese Patent Application No. 2021-165461, filed Oct. 7, 2021, the entire contents of each are incorporated herein by reference.

### BACKGROUND

### Technical Field

The present disclosure relates to a ferrite sintered body and a multilayer coil component.

### Background Art

Japanese Unexamined Patent Application Publication No. 2019-210204 discloses a composite magnetic material containing a ferrite composition and zinc silicate, the ferrite composition containing a spinel ferrite and bismuth oxide present in the spinel ferrite, in which the ratio of the weight of the bismuth oxide to the weight of the entire composite magnetic material is 0.025 wt % or more and 0.231 wt % or less (i.e., from 0.025 wt % to 0.231 wt %), and the ratio of the weight of the zinc silicate to the total weight of the zinc silicate and the spinel ferrite is 8 wt % or more and 76 wt % or less (i.e., from 8 wt % to 76 wt %).

### SUMMARY

According to Japanese Unexamined Patent Application Publication No. 2019-210204, when the ratio of the weight of bismuth oxide to the weight of the entire composite magnetic material is 0.025 wt % or more and 0.231 wt % or less (i.e., from 0.025 wt % to 0.231 wt %), the sinterability of the composite magnetic material is improved, and a high resistivity can be secured. Furthermore, it is described that, when the ratio of the weight of zinc silicate to the total weight of zinc silicate and spinel ferrite is 8 wt % or more and 76 wt % or less (i.e., from 8 wt % to 76 wt %), a high magnetic permeability and a good DC superposition characteristic can both be achieved.

However, increasing the zinc silicate content in the composite magnetic material described in Japanese Unexamined Patent Application Publication No. 2019-210204 in order to improve the DC superposition characteristic may degrade the sinterability. Meanwhile, increasing the bismuth oxide content in order to improve the sinterability may degrade reliability of electronic components due to occurrence of defects known as “plating elongation”, that is, elongation of a plating electrode, which constitutes an outer electrode of an electronic component such as a multilayer coil component, with respect to a base electrode.

The present disclosure is made to address the aforementioned issues, and aims to provide a ferrite sintered body that has a good DC superposition characteristic and good sinterability and causes less plating elongation. The present disclosure also aims to provide a multilayer coil component that includes insulating layers composed of the ferrite sintered body.

A ferrite sintered body according to the present disclosure contains a main component and a sub component. The main component contains 4 mol % or more and 13 mol % or less of Fe (i.e., from 4 mol % to 13 mol %) in terms of Fe₂O₃, 47 mol % or more and 58 mol % or less (i.e., from 47 mol % to 58 mol %) of Zn in terms of ZnO, 1 mol % or more and 4 mol % or less (i.e., from 1 mol % to 4 mol %) of Cu in terms of CuO, 2 mol % or more and 8 mol % or less (i.e., from 2 mol % to 8 mol %) of Ni in terms of NiO, and 28 mol % or more and 36 mol % or less (i.e., from 28 mol % to 36 mol %) of Si in terms of SiO₂. The sub component contains, per 100 parts by weight of the main component, 0.8 parts by weight or more and 3 parts by weight or less (i.e., from 0.8 parts by weight to 3 parts by weight) of Bi in terms of Bi₂O₃ and 0.005 parts by weight or more and 0.1 parts by weight or less (i.e., from 0.005 parts by weight to 0.1 parts by weight) of Zr in terms of ZrO₂.

A multilayer coil component according to the present disclosure includes a multilayer body in which insulating layers composed of the ferrite sintered body of the present disclosure and coil conductors are alternately stacked.

According to the present disclosure, a ferrite sintered body that has a good DC superposition characteristic and good sinterability and causes less plating elongation can be provided. Furthermore, according to the present disclosure, a multilayer coil component that includes insulating layers composed of the ferrite sintered body can be provided.

### BRIEF DESCRIPTION OF THE DRAWINGS

FIG. 1 is a schematic perspective view illustrating one example of a multilayer coil component of the present disclosure;

FIG. 2 is an exploded plan view schematically illustrating one example of the inner structure of a multilayer body constituting the multilayer coil component illustrated in FIG. 1;

FIG. 3 is a schematic cross-sectional view illustrating one example of a multilayer coil component that includes the multilayer body illustrated in FIG. 2; and

FIG. 4 is an enlarged view of a part indicated by IV in FIG. 3.

### DETAILED DESCRIPTION

Hereinafter, a ferrite sintered body and a multilayer coil component according to the present disclosure are described. However, the present disclosure is not limited to the features described below and is subject to modifications as appropriate without changing the gist of the present disclosure. Note that any combination of two or more desirable features of the present disclosure described below is also included in the present disclosure.

### Ferrite Sintered Body

A ferrite sintered body according to the present disclosure contains a main component and a sub component.

The main component contains 4 mol % or more and 13 mol % or less (i.e., from 4 mol % to 13 mol %) of Fe in terms of Fe₂O₃, 47 mol % or more and 58 mol % or less (i.e., from 47 mol % to 58 mol %) of Zn in terms of ZnO, 1 mol % or more and 4 mol % or less (i.e., from 1 mol % to 4 mol %) of Cu in terms of CuO, 2 mol % or more and 8 mol % or less (i.e., from 2 mol % to 8 mol %) of Ni in terms of NiO, and 28 mol % or more and 36 mol % or less (i.e., from 28 mol % to 36 mol %) of Si in terms of SiO₂. Here, the total of Fe₂O₃, ZnO, CuO, NiO, and SiO₂ is 100 mol %.

The sub component contains, per 100 parts by weight of the main component, 0.8 parts by weight or more and 3 parts by weight or less (i.e., from 0.8 parts by weight to 3 parts by weight) of Bi in terms of Bi₂O₃ and 0.005 parts by weight or more and 0.1 parts by weight or less (i.e., from 0.005 parts by weight to 0.1 parts by weight) of Zr in terms of ZrO₂.

When the composition of the ferrite sintered body is within the aforementioned range, a ceramic composition that has a good DC superposition characteristic and good sinterability and causes less plating elongation can be obtained. For example, a ceramic composition with which the applied magnetic field at which the magnetic permeability is −10% from the initial magnetic permeability is 15000 A/m or more and which sufficiently sinters by firing at 920° C. for 3 hours and causes less plating elongation can be obtained.

The content of each element can be determined by analyzing the composition of the sintered body by inductively coupled plasma atomic emission spectrometry/mass spectrometry (ICP-AES/MS).

The main component of the ferrite sintered body according to the present disclosure preferably contains 4 mol % or more and 9 mol % or less (i.e., from 4 mol % to 9 mol %) of Fe in terms of Fe₂O₃, 52 mol % or more and 58 mol % or less (i.e., from 52 mol % to 58 mol %) of Zn in terms of ZnO, 1 mol % or more and 3 mol % or less (i.e., from 1 mol % to 3 mol %) of Cu in terms of CuO, 2 mol % or more and 5 mol % or less (i.e., from 2 mol % to 5 mol %) of Ni in terms of NiO, and 31 mol % or more and 36 mol % or less (i.e., from 31 mol % to 36 mol %) of Si in terms of SiO₂. Here, the total of Fe₂O₃, ZnO, CuO, NiO, and SiO₂ is 100 mol %.

When the Fe, Zn, Cu, Ni, and Si contents are within the aforementioned ranges, the DC superposition characteristic can be further improved. For example, a ceramic composition with which the applied magnetic field at which the magnetic permeability is −10% from the initial magnetic permeability is 18000 A/m or more can be obtained.

The sub component of the ferrite sintered body according to the present disclosure may further contain, per 100 parts by weight of the main component, 0.003 parts by weight or more and 0.1 parts by weight or less (i.e., from 0.003 parts by weight to 0.1 parts by weight) of Mn in terms of Mn₂O₃ and 0.003 parts by weight or more and 0.1 parts by weight or less (i.e., from 0.003 parts by weight to 0.1 parts by weight) of Cr in terms of Cr₂O₃.

When the sub component contains Mn and Cr in the aforementioned ranges, the DC superposition characteristic can be further improved.

The ferrite sintered body according to the present disclosure preferably has an average crystal grain size of 0.2 μm or more and 0.8 μm or less (i.e., from 0.2 μm to 0.8 μm).

The smaller the average crystal grain size of the ferrite sintered body, the larger the ratio of the grain boundaries to the crystal grains. For example, when non-magnetic phases are included in the ferrite sintered body, magnetic saturation tends to be suppressed, and thus the DC superposition characteristic can be improved. Thus, when the average crystal grain size of the ferrite sintered body is within the aforementioned range, the non-magnetic phases easily penetrate into the grain boundaries and thus the DC superposition characteristic can be further improved.

In this description, the average crystal grain size of the ferrite sintered body means an equivalent area diameter (D50) at which the number-based cumulative distribution percentage reaches 50% in a cumulative distribution of equivalent area diameters of the crystal grains. The equivalent area diameters of the crystal grains can be measured by observing a cross section of the ferrite sintered body with a scanning electron microscope (SEM).

The ferrite sintered body of the present disclosure preferably includes a magnetic phase containing at least Fe, Ni, Zn, and Cu and a non-magnetic phase containing at least Si and Zn.

When non-magnetic phases are contained in the ferrite sintered body, magnetic saturation tends to be suppressed as described above, and thus the DC superposition characteristic can be improved.

The magnetic phase and the non-magnetic phase can be distinguished as follows. First, a cross section of a ferrite sintered body is subjected to scanning transmission electron microscope/energy dispersive X-ray analysis (STEM-EDX) to obtain an element map. Then a region where Fe is present can be identified as a magnetic phase and a region where Si is present can be identified as a non-magnetic phase.

### Multilayer Coil Component

A multilayer coil component of the present disclosure includes a multilayer body in which insulating layers composed of the ferrite sintered body of the present disclosure and coil conductors are alternately stacked.

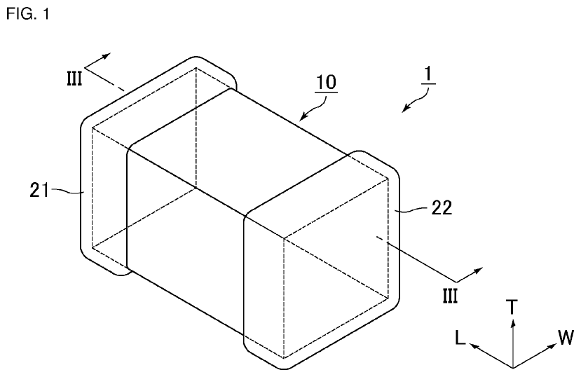

FIG. 1 is a schematic perspective view illustrating one example of a multilayer coil component of the present disclosure.

The multilayer coil component 1 illustrated in FIG. 1 includes a multilayer body 10. The multilayer coil component 1 further includes outer electrodes 21 and 22 disposed on outer surfaces of the multilayer body 10. The number of outer electrodes, the positions where the outer electrodes are present, etc., are subject to modification as appropriate depending on the type of the multilayer coil component.

The multilayer body 10 has, for example, a rectangular parallelepiped shape or a substantially rectangular parallelepiped shape. In FIG. 1, L indicates the length direction, W indicates the width direction, and T indicates the height direction. The length direction L, the width direction W, and the height direction T are orthogonal to one another.

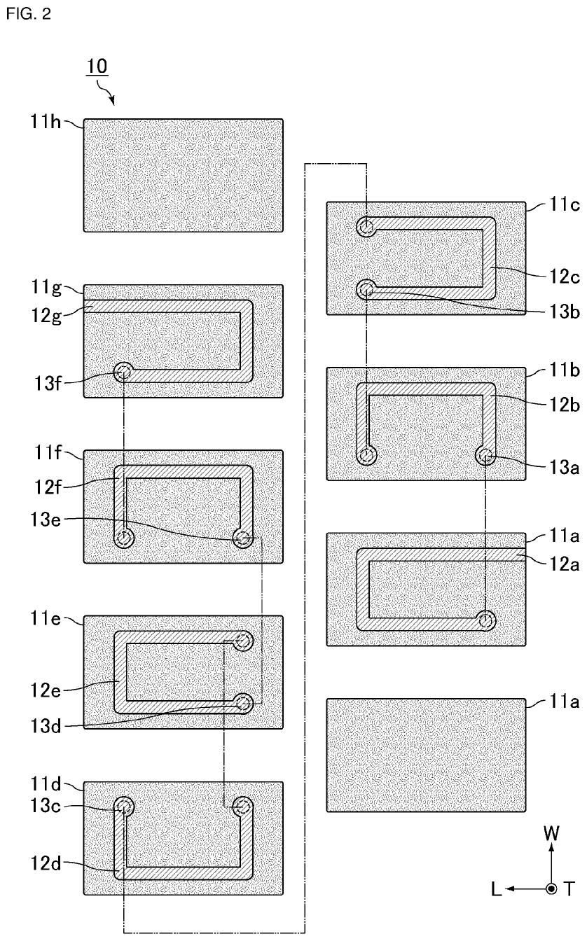

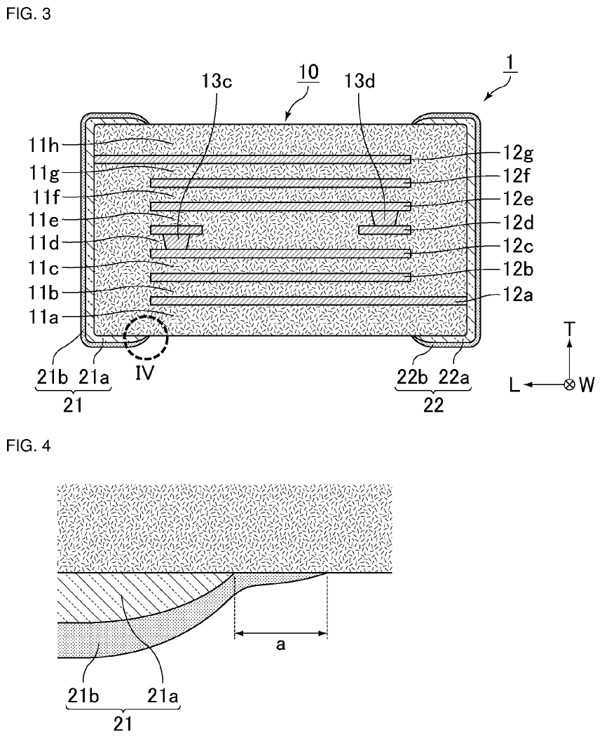

FIG. 2 is an exploded plan view schematically illustrating one example of the inner structure of a multilayer body constituting the multilayer coil component illustrated in FIG. 1. FIG. 3 is a schematic cross-sectional view illustrating one example of a multilayer coil component that includes the multilayer body illustrated in FIG. 2. Here, FIG. 3 corresponds to a cross-sectional view of the multilayer coil component illustrated in FIG. 1 taken along line III-III.

In the example illustrated in FIGS. 2 and 3, the multilayer body 10 includes insulating layers 11a, 11b, 11c, 11d, 11e, 11f, 11g, and 11h and coil conductors 12a, 12b, 12c, 12d, 12e, 12f, and 12g that are alternately stacked. A coil is formed as the coil conductors 12a, 12b, 12c, 12d, 12e, 12f, and 12g are electrically connected via conductors 13a, 13b, 13c, 13d, 13e, 13f. In the example illustrated in FIGS. 2 and 3, the multilayer coil component 1 has a vertically wound structure in which the coil conductors are stacked in the height direction T; alternatively, the multilayer coil component 1 may have a horizontally wound structure in which the coil conductors are stacked in the length direction L or the width direction W.

The insulating layers 11a, 11b, 11c, 11d, 11e, 11f, 11g, and 11h are all composed of the ferrite sintered body of the present disclosure.

The coil conductors 12a, 12b, 12c, 12d, 12e, 12f, and 12g are, for example, all composed of Ag or the like. Similarly, the via conductors 13a, 13b, 13c, 13d, 13e, and 13f are, for example, all composed of Ag or the like.

In the example illustrated in FIG. 3, the outer electrode 21 includes, in order from the side close to the multilayer body 10, a base electrode 21a and a plating electrode 21b disposed on the base electrode 21a. In the same manner, the outer electrode 22 includes, in order from the side close to the multilayer body 10, a base electrode 22a and a plating electrode 22b disposed on the base electrode 22a.

The base electrodes 21a and 22a preferably both contain Ag.

The plating electrodes 21b and 22b may each have a single-layer structure or a multilayer structure. When the plating electrode 21b has a multilayer structure, the plating electrode 21b preferably includes, in order from the side close to the base electrode 21a, a Ni plating electrode and a Sn plating electrode. Similarly, when the plating electrode 22b has a multilayer structure, the plating electrode 22b preferably includes, in order from the side close to the base electrode 22a, a Ni plating electrode and a Sn plating electrode.

FIG. 4 is an enlarged view of a part indicated by IV in FIG. 3.

In the outer electrode 21, the length (the dimension indicated by a in FIG. 4) of the plating electrode 21b extending from the tip of the base electrode 21a is preferably 30 μm or less. The length of the plating electrode 21b extending from the tip of the base electrode 21a may be 0 μm or may be larger than 0 μm.

Similarly, in the outer electrode 22, the length of the plating electrode 22b extending from the tip of the base electrode 22ais preferably 30 μm or less. The length of the plating electrode 22b extending from the tip of the base electrode 22amay be 0 μm or may be larger than 0 μm.

A multilayer coil component that includes insulating layers composed of the ferrite sintered body of the present disclosure is preferably produced as follows.

### Magnetic Material Production Step

Fe₂O₃, ZnO, CuO, and NiO are weighed into a particular composition. This blend material, pure water, and partially stabilized zirconia (PSZ) balls are placed in a ball mill and mixed and pulverized in a wet manner for a particular length of time (for example, 4 hours or longer and 8 hours or shorter (i.e., from 4 hours to 8 hours)). After the moisture is evaporated to dry, calcining is performed at a particular temperature (for example, 700° C. or higher and 800° C. or lower (i.e., from 700° ° C. to 800° C.)) for a particular length of time (for example, 2 hours or longer and 5 hours or shorter (i.e., from 2 hours to 5 hours)). As a result, a magnetic material, specifically, a Ni-Cu-Zn ferrite powder, is produced.

The magnetic material, which is a calcined product, is preferably pulverized again so that the average particle size D50 is about 0.1 μm or more and 0.2 μm or less (i.e., 0.1 um to 0.2 μm).

The Ni-Cu-Zn ferrite powder obtained after the calcining preferably contains 40 mol % or more and 49.5 mol % or less (i.e., from 40 mol % to 49.5 mol %) of Fe in terms of Fe₂O₃, 2 mol % or more and 35 mol % or less (i.e., from 2 mol % to 35 mol %) of Zn in terms of ZnO, 6 mol % or more and 13 mol % or less (i.e., from 6 mol % to 13 mol %) of Cu in terms of CuO, and 10 mol % or more and 45 mol % or less (i.e., from 10 mol % to 45 mol %) of Ni in terms of NiO. The Ni—Cu—Zn ferrite powder may contain additives such as Co, Bi, Sn, and Mn, unavoidable impurities, etc.

### Non-Magnetic Material Production Step

SiO₂and ZnO are weighed into particular composition. Here, SiO₂and ZnO are preferably blended so that the molar ratio of ZnO to SiO₂is 1.8 or more and 2.2 or less (i.e., from 1.8 to 2.2). This blend material, pure water, and PSZ balls are placed in a ball mill and mixed and pulverized in a wet manner for a particular length of time (for example, 4 hours or longer and 8 hours or shorter (i.e., from 4 hours to 8 hours)). After the moisture is evaporated to dry, calcining is performed at a particular temperature (for example, 1000° C. or higher and 1300° C. or lower (i.e., from 1000° ° C. to 1300° C.)) for a particular length of time (for example, 2 hours or longer and 5 hours or shorter (i.e., from 2 hours to 5 hours)). As a result, a non-magnetic material, specifically, a zinc silicate powder, is produced.

The non-magnetic material, which is a calcined product, is preferably pulverized again so that the average particle size D50 is about 0.1 μm or more and 0.2 μm or less (i.e., from 0.1 μm to 0.2 μm).

Separately, a SiO₂powder having an average particle size D50 of about 0.1 μm or more and 0.2 μm or less (i.e., from 0.1 μm to 0.2 μm) is prepared as a non-magnetic material.

The average particle sizes D50 of the magnetic material and the non-magnetic materials described above are diameters corresponding to a cumulative volume percentage of 50% obtained by laser diffraction/scattering particle size distribution measurement.

### Green Sheet Production Step

The magnetic material and the non-magnetic materials produced by the aforementioned steps are blended at a particular ratio. Furthermore, particular amounts of Bi₂O₃ and ZrO₂ are added thereto. If necessary, particular amounts of Mn₂O₃ and Cr₂O₃. are added thereto. The resulting blend and PSZ media are placed in a ball mill and further mixed with an organic binder such as a polyvinyl butyral resin, an organic solvent such as ethanol or toluene, a plasticizer, etc., to prepare a slurry. The obtained slurry is processed into sheets having a particular thickness (for example, 20 μm or more and 30 μm or less (i.e., from 20 μm to 30 μm)) by a doctor blade method or the like. Next, the sheets were punched out into a particular shape (for example, a rectangular shape) to produce green sheets.

### Coil Conductor Pattern Forming Step

The prepared green sheets are irradiated with a laser to form via holes at particular positions. Next, a conductive paste mainly composed of Ag or the like is applied to the surfaces of the green sheets by a screen printing method or the like, thereby filling the via holes as well. As a result, coil conductor patterns are formed on the green sheets.

### Multilayer Body Block Production Step

The green sheets with the coil conductor patterns formed thereon and the green sheets without any coil conductor patterns are stacked in a particular order (for example, in the order illustrated in FIG. 2). The stacked green sheets are thermally press-bonded to produce a multilayer body block.

### Singulation Step

If necessary, the multilayer body block is cut into a particular size with a dicer or the like to form singulated chips.

### Firing Step

The singulated chips are fired at a particular temperature (for example, 900° C. or higher and 920° C. or lower (i.e., from 900° ° C. to 920° C.)) for a particular length of time (for example, 2 hours or longer and 4 hours or shorter (i.e., from 2 hours to 4 hours)).

As a result of firing, the green sheets turn into insulating layers composed of a ferrite sintered body, and the coil conductor patterns turn into coil conductors and via conductors. Thus, a multilayer body in which insulating layers and coil conductors are alternately stacked is produced.

### Polishing Step

The fired multilayer body may be, for example, barrel-polished to round the corners and ridges of the multilayer body. A corner is where three surfaces of the multilayer body meet, and a ridge is where two surfaces of the multilayer body meet.

### Outer Electrode Forming Step

A conductive paste is applied to end surfaces, which are side surfaces of the multilayer body, where the coil conductors are drawn out. The conductive paste contains, for example, Ag and glass. The conductive paste is baked at a particular temperature (for example, 800° C. or higher and 820° C. or lower (i.e., from 800° C. to 820° C.)) to form base electrodes of the outer electrodes. The thickness of the base electrode is, for example, about 5 μm.

Next, electrolytic plating or the like is performed to sequentially form, for example, a Ni plating electrode and a Sn plating electrode on the base electrode. Thus, outer electrodes are formed.

A multilayer coil component is produced through the aforementioned process. The dimensions of the multilayer coil component are, for example, 0.6 mm in the length direction L, 0.3 mm in the width direction W, and 0.3 mm in the height direction T.

### EXAMPLES

Hereinafter, Examples that more specifically disclose the ferrite sintered body and the multilayer coil component according to the present disclosure are described. However, the present disclosure is not limited to these examples.

### Example 1

### Preparation of Sample

48 mol % of Fe₂O₃, 10 mol % of ZnO, 28 mol % of NiO, and 14 mol % of CuO were blended. The resulting blend was wet-mixed, pulverized, and dried to remove moisture. The obtained dry product was calcined at a temperature of 800° C. for 2 hours. The obtained calcined product was wet-pulverized until the average particle size D50 was 0.2 μm. Thus, a ferrite powder serving as a magnetic material was prepared.

Next, ZnO and SiO₂ were mixed at a ZnO-to-SiO₂ molar ratio of 2:1. The resulting blend was wet-mixed, pulverized, and dried to remove moisture. The obtained dry product was calcined at a temperature of 1100° C. for 2 hours. The obtained calcined product was wet-pulverized until the average particle size D50 was 0.2 μm. Thus, a zinc silicate powder was prepared. Furthermore, a SiO₂ powder having an average particle size D50 of 0.2 μm was prepared. The zinc silicate powder and the SiO₂ powder were used as the non-magnetic materials.

The magnetic material and the non-magnetic materials were weighed so that the magnetic material-to-non-magnetic material volume ratio was 35:65 to 5:95, and then particular amounts of Bi₂O₃ and ZrO₂ were added thereto. Particular amounts of an organic binder, an organic solvent, and a plasticizer were placed in a ball mill and mixed to prepare a slurry. The obtained slurry was formed into sheets having a thickness of about 25 μm by a doctor blade method, and the sheets were punched out into a rectangular shape to prepare green sheets.

The prepared green sheets were stacked and press-bonded to produce a multilayer body block. The multilayer body block was punched out into a ring shape and fired at 920° C. for 3 hours to form a ring-shaped sample having an outer diameter of 20 mm, an inner diameter of 12 mm, and a thickness of 1.5 mm.

By using the prepared green sheets, the procedures set forth in <Coil conductor pattern forming step> to <Outer electrode forming step> above were conducted to prepare a multilayer coil component.

### Composition

The ring-shaped sample was subjected to inductively coupled plasma atomic emission spectrometry/mass spectrometry (ICP-AES/MS) to have the composition analyzed. The results are shown in Table 1.

### Magnetic Permeability

The ring-shaped sample was set on a magnetic body measurement jig (model number: 16454A) produced by Agilent Technologies and the magnetic permeability μ′ at 10 MHz was measured by using an impedance analyzer (model number: E4991A) produced by Agilent Technologies. The results are shown in Table 1.

### DC Superposition Characteristic

A wire was wound 60 turns around the ring-shaped sample, and a DC current was applied by using an LCR meter 4284A produced by Agilent to measure the calculated applied magnetic field and the magnetic permeability detected thereat and to determine the applied magnetic field at which the magnetic permeability was −10% from the initial magnetic permeability. The results are shown in Table 1.

### Plating Elongation

For each of the samples, five multilayer coil components were immobilized in a resin and polished by a polisher in a sample width direction (W direction). The polishing was ended at a depth where a substantially center portion of the sample was exposed. The obtained section was subjected to focused ion beam (FIB) processing to obtain a section for SEM observation. The FIB processing was performed by using FIB processor SMI3050R produced by SII NanoTechnology. A SEM image of a tip portion of the base electrode was taken, and the length (the dimension indicated by a in FIG. 4) of the plating electrode extending from the tip of the base electrode was measured from the SEM image. The case in which even one out of five samples had more than 30 μm of the plating electrode extending from the tip of the base electrode was evaluated as x (poor), and the case in which there were no such samples was evaluated as o (good). The results are shown in Table 1.

### Average Crystal Grain Size

For each of the samples, a SEM image of a substantially center portion of a multilayer coil component was taken, and the average crystal grain size D50 of the ferrite sintered body was measured. The observation area was 8 μm×8 μm. The average crystal grain size D50 is an equivalent area diameter at which the number-based cumulative distribution percentage reaches 50% in a cumulative distribution of the measured equivalent area diameters of the crystal grains. The results are shown in Table 1.

TABLE 1

| | | | | | | Sub component | | Average | | | |
|---|---|---|---|---|---|---|---|---|---|---|---|
| | | | | | | Bi₂O₃ | ZrO₂ | crystal | | Magnetic | DC |
| | Main component | | | | | (parts | (parts | grain | | permeability | superposition |
| Sample | Fe₂O₃ | ZnO | CuO | NiO | SiO₂ | by | by | size | Plating | μ′ | characteristic |
| No. | (mol %) | (mol %) | (mol %) | (mol %) | (mol %) | weight) | weight) | (μm) | elongation | (—) | (A/m) |
| *1 | 15.14 | 45.35 | 4.38 | 8.8 | 26.33 | 2 | 0.015 | 0.42 | ∘ | 3.2 | 14000 |
| 2 | 12.87 | 47.77 | 3.73 | 7.48 | 28.15 | 2 | 0.015 | 0.41 | ∘ | 2.6 | 15300 |
| 3 | 10.34 | 50.47 | 3 | 6.01 | 30.18 | 2 | 0.015 | 0.39 | ∘ | 2.0 | 17000 |
| 4 | 8.45 | 52.5 | 2.45 | 4.91 | 31.69 | 2 | 0.015 | 0.37 | ∘ | 1.7 | 18600 |
| 5 | 6.29 | 54.81 | 1.82 | 3.66 | 33.42 | 2 | 0.015 | 0.36 | ∘ | 1.4 | 19500 |
| 6 | 4.16 | 57.09 | 1.21 | 2.42 | 35.12 | 2 | 0.015 | 0.35 | ∘ | 1.2 | 20400 |
| *7 | 2.08 | 59.32 | 0.6 | 1.21 | 36.79 | 2 | 0.015 | Insufficient sintering | | | |
| *8 | 6.29 | 54.81 | 1.82 | 3.66 | 33.42 | 0 | 0.015 | Insufficient sintering | | | |
| 9 | 6.29 | 54.81 | 1.82 | 3.66 | 33.42 | 0.8 | 0.015 | 0.41 | ∘ | 1.7 | 18000 |
| 10 | 6.29 | 54.81 | 1.82 | 3.66 | 33.42 | 1 | 0.015 | 0.40 | ∘ | 1.6 | 18600 |
| 11 | 6.29 | 54.81 | 1.82 | 3.66 | 33.42 | 3 | 0.015 | 0.60 | ∘ | 1.3 | 20300 |
| *12 | 6.29 | 54.81 | 1.82 | 3.66 | 33.42 | 4 | 0.015 | 0.95 | x | 1.2 | 20800 |
| *13 | 6.29 | 54.81 | 1.82 | 3.66 | 33.42 | 2 | 0 | 0.45 | x | 1.6 | 18300 |
| 14 | 6.29 | 54.81 | 1.82 | 3.66 | 33.42 | 2 | 0.005 | 0.42 | ∘ | 1.6 | 18600 |
| 15 | 6.29 | 54.81 | 1.82 | 3.66 | 33.42 | 2 | 0.01 | 0.41 | ∘ | 1.5 | 19100 |
| 16 | 6.29 | 54.81 | 1.82 | 3.66 | 33.42 | 2 | 0.03 | 0.37 | ∘ | 1.3 | 20300 |
| 17 | 6.29 | 54.81 | 1.82 | 3.66 | 33.42 | 2 | 0.05 | 0.35 | ∘ | 1.2 | 20800 |
| 18 | 6.29 | 54.81 | 1.82 | 3.66 | 33.42 | 2 | 0.1 | 0.35 | ∘ | 1.2 | 21100 |

| | | | | | | | | |
|---|---|---|---|---|---|---|---|---|
| *19 | 6.29 | 54.81 | 1.82 | 3.66 | 33.42 | 2 | 0.5 | Insufficient sintering |

In Table 1, asterisked samples are comparative examples outside the scope of the present disclosure.

Table 1 indicates that, in samples 2 to 6, 9 to 11, and 14 to 18 in which the main component contained 4 mol % or more and 13 mol % or less (i.e., from 4 mol % to 13 mol %) of Fe in terms of Fe₂O₃, 47 mol % or more and 58 mol % or less (i.e., from 47 mol % to 58 mol %) of Zn in terms of ZnO, 1 mol % or more and 4 mol % or less (i.e., from 1 mol % to 4 mol %) of Cu in terms of CuO, 2 mol % or more and 8 mol % or less (i.e., from 2 mol % to 8 mol %) of Ni in terms of NiO, and 28 mol % or more and 36 mol % or less (i.e., from 28 mol % to 36 mol %) of Si in terms of SiO₂ and in which the sub component contained, per 100 parts by weight of the main component, 0.8 parts by weight or more and 3 parts by weight or less (i.e., from 0.8 parts by weight to 3 parts by weight) of Bi in terms of Bi₂O₃ and 0.005 parts by weight or more and 0.1 parts by weight or less (i.e., from 0.005 parts by weight to 0.1 parts by weight) of Zr in terms of ZrO₂, ferrite sintered bodies that had a magnetic permeability μ′ of 1.2 or more and a DC superposition characteristic of 15000 A/m or more, had sufficiently sintered by firing at 920° C. for 3 hours, and caused less plating elongation were obtained.

In particular, in samples 4 to 6, 9 to 11, and 14 to 18 in which the main component contained 4 mol % or more and 9 mol % or less (i.e., from 4 mol % to 9 mol %) of Fe in terms of Fe₂O₃, 52 mol % or more and 58 mol % or less (i.e., from 52 mol % to 58 mol %) of Zn in terms of ZnO, 1 mol % or more and 3 mol % or less (i.e., from 1 mol % to 3 mol %) of Cu in terms of CuO, 2 mol % or more and 5 mol % or less (i.e., from 2 mol % to 5 mol %) of Ni in terms of NiO, and 31 mol % or more and 36 mol % or less of (i.e., from 31 mol % to 36 mol %) Si in terms of SiO₂, ferrite sintered bodies having a DC superposition characteristic of 18000 A/m or more were obtained.

Sample 1 had a DC superposition characteristic of 14000 A/m, which was below 15000 A/m.

In samples 7, 8, and 19, the sinterability was poor, and sufficient sintering did not occur by firing at 920° C. for 3 hours.

In sample 12 in which the amount of Bi₂O₃ added was large and in sample 13 in which no ZrO₂ was added, plating elongation occurred.

### Example 2

Samples 21 to 27 were prepared by using the composition of sample 5 indicated in Table 1 with Mn and Cr added thereto, and the evaluation was conducted as in Example 1. The results are shown in Table 2.

TABLE 2

| | Sub component | | Average | | Magnetic | DC |
|---|---|---|---|---|---|---|
| | Mn₂O₃ | Cr₂O₃ | crystal | | permeability | superposition |
| Sample | (parts by | (parts by | grain size | Plating | μ′ | characteristic |
| No. | weight) | weight) | (μm) | elongation | (—) | (A/m) |
| 5 | 0 | 0 | 0.36 | ∘ | 1.4 | 19500 |
| 21 | 0.003 | 0.01 | 0.36 | ∘ | 1.4 | 19600 |
| 22 | 0.01 | 0.01 | 0.35 | ∘ | 1.4 | 19800 |
| 23 | 0.05 | 0.01 | 0.35 | ∘ | 1.3 | 20500 |
| 24 | 0.1 | 0.01 | 0.35 | ∘ | 1.2 | 21000 |
| 25 | 0.02 | 0.003 | 0.36 | ∘ | 1.4 | 19500 |
| 26 | 0.02 | 0.05 | 0.35 | ∘ | 1.2 | 20400 |
| 27 | 0.02 | 0.1 | 0.35 | ∘ | 1.2 | 20900 |

Table 2 indicates that, in samples 21 to 27 in which the sub component contained, per 100 parts by weight of the main component, 0.003 parts by weight or more and 0.1 parts by weight or less (i.e., from 0.003 parts by weight to 0.1 parts by weight) of Mn in terms of Mn₂O₃ and 0.003 parts by weight or more and 0.1 parts by weight or less (i.e., from 0.003 parts by weight to 0.1 parts by weight) of Cr in terms of Cr₂O₃, DC superposition characteristics comparable or superior to that of sample 5 were obtained.

What is claimed is:

1. A ferrite sintered body comprising a main component and a sub component, wherein the main component includes
from 4 mol % to 13 mol % of Fe in terms of Fe₂O₃,
from 47 mol % to 58 mol % of Zn in terms of ZnO,
from 1 mol % to 4 mol % of Cu in terms of CuO,
from 2 mol % to 8 mol % of Ni in terms of NiO, and
from 28 mol % to 36 mol % of Si in terms of SiO₂,
and
the sub component includes, per 100 parts by weight of the main component,
from 0.8 parts by weight to 3 parts by weight of Bi in terms of Bi₂O₃ and
from 0.005 parts by weight to 0.1 parts by weight of Zr in terms of ZrO₂.

2. The ferrite sintered body according to claim 1, wherein
the main component includes
from 4 mol % to 9 mol % of Fe in terms of Fe₂O₃,
from 52 mol % to 58 mol % of Zn in terms of ZnO,
from 1 mol % to 3 mol % of Cu in terms of CuO,
from 2 mol % to 5 mol % of Ni in terms of NiO, and
from 31 mol % to 36 mol % of Si in terms of SiO₂.

3. The ferrite sintered body according to claim 1, wherein
the sub component further includes, per 100 parts by weight of the main component,
from 0.003 parts by weight to 0.1 parts by weight of Mn in terms of Mn₂O₃ and
from 0.003 parts by weight to 0.1 parts by weight of Cr in terms of Cr₂O₃.

4. The ferrite sintered body according to claim 1, wherein
the ferrite sintered body has an average crystal grain size of from 0.2 μm to 0.8 μm.

5. The ferrite sintered body according to claim 1, wherein
the ferrite sintered body includes a magnetic phase including at least Fe, Ni, Zn, and Cu and a non-magnetic phase containing at least Si and Zn.

6. A multilayer coil component comprising:
a multilayer body in which insulating layers comprising the ferrite sintered body according to claim 1, and coil conductors are alternately stacked.

7. The ferrite sintered body according to claim 2, wherein
the sub component further includes, per 100 parts by weight of the main component,
from 0.003 parts by weight to 0.1 parts by weight of Mn in terms of Mn₂O₃ and
from 0.003 parts by weight to 0.1 parts by weight of Cr in terms of Cr₂O₃.

8. The ferrite sintered body according to claim 2, wherein
the ferrite sintered body has an average crystal grain size of from 0.2 μm to 0.8 μm.

9. The ferrite sintered body according to claim 3, wherein
the ferrite sintered body has an average crystal grain size of from 0.2 μm to 0.8 μm.

10. The ferrite sintered body according to claim 7, wherein
the ferrite sintered body has an average crystal grain size of from 0.2 μm to 0.8 μm.

11. The ferrite sintered body according to claim 2, wherein
the ferrite sintered body includes a magnetic phase including at least Fe, Ni, Zn, and Cu and a non-magnetic phase containing at least Si and Zn.

12. The ferrite sintered body according to claim 3, wherein
the ferrite sintered body includes a magnetic phase including at least Fe, Ni, Zn, and Cu and a non-magnetic phase containing at least Si and Zn.

13. The ferrite sintered body according to claim 4, wherein
the ferrite sintered body includes a magnetic phase including at least Fe, Ni, Zn, and Cu and a non-magnetic phase containing at least Si and Zn.

14. The ferrite sintered body according to claim 7, wherein
the ferrite sintered body includes a magnetic phase including at least Fe, Ni, Zn, and Cu and a non-magnetic phase containing at least Si and Zn.

15. The ferrite sintered body according to claim 8, wherein
the ferrite sintered body includes a magnetic phase including at least Fe, Ni, Zn, and Cu and a non-magnetic phase containing at least Si and Zn.

16. The ferrite sintered body according to claim 9, wherein
the ferrite sintered body includes a magnetic phase including at least Fe, Ni, Zn, and Cu and a non-magnetic phase containing at least Si and Zn.

17. The ferrite sintered body according to claim 10, wherein
the ferrite sintered body includes a magnetic phase including at least Fe, Ni, Zn, and Cu and a non-magnetic phase containing at least Si and Zn.

18. A multilayer coil component comprising:
a multilayer body in which insulating layers comprising the ferrite sintered body according to claim 2, and coil conductors are alternately stacked.

19. A multilayer coil component comprising:
a multilayer body in which insulating layers comprising the ferrite sintered body according to claim 3, and coil conductors are alternately stacked.

20. A multilayer coil component comprising:
a multilayer body in which insulating layers comprising the ferrite sintered body according to claim 4, and coil conductors are alternately stacked.
